(19) United States
(12) Patent Application Publication
(10) Pub. No.: US 2006/0052069 A1
(43) Pub. Date: Mar. 9, 2006

(54) Communication apparatus

(76) Inventors: Kazuya Odagiri, Kanagawa (JP); Takashi Sasai, Kanagawa (JP); Hiroshi Kakuda, Tokyo (JP); Koji Nishimura, Tokyo (JP)

Correspondence Address: William S Frommer;Frommer Lawrence & Haug, 745 Fifth Avenue, New York, NY, 10151, US

(21) Appl. No.: 10/517,221

(22) PCT Filed: Jun. 9, 2003
(86) PCT No.: PCT/JP03/07287

§ 371 Date: Aug. 8, 2005

(30) Foreign Application Priority Data
Jun. 10, 2002 (JP) 2002-169012

(51) Int. Cl. H04M 1/00; H04Q 7/20; H01Q 11/12; H04B 1/38; H04B 7/00; H04B 1/04

(52) U.S. Cl. 455/127.1; 455/522; 455/574

(57) ABSTRACT

A communication apparatus which performs wireless communication with other communication devices existing in the neighborhood, includes: a transmission processing element 13 for processing a transmission signal; an antenna 17 for wirelessly transmitting an output of the transmission processing element 13; and an output power regulation element 16 for attenuating the output of the transmission processing element 13 to be output from the antenna 17 when a search signal to search for other communication devices is transmitted in a predetermined state from the transmission processing element 13. With such configuration, when a signal to search for other devices existing in the neighborhood is transmitted in short range wireless communication, a communication range can be restricted using a simple structure.

### TECHNICAL FIELD

The present invention relates to a communication apparatus suitable to be applied to a communication method of performing comparatively short range wireless communication.

### BACKGROUND ART

In recent years, a communication method called Bluetooth® communication has attracted an attention as a close range wireless communication method up to approximately 100 m at maximum and various kinds of supporting device have been developed.

A close range wireless communication system such as the Bluetooth® communication which uses a wireless signal of a comparatively high frequency wave (for example, 2 MHz band) has an advantage such as no directivity and high transmissivity in comparison to an infrared data communication method which uses an infrared signal, and it is expected that devices supporting the system increase in the future.

In a communication system to which the infrared data communication method is applied, in order to establish a connection for the communication it has been necessary to specify a device to establish communication with a light emitting portion of a device and a light receiving portion of another device, which are mutually a connection target, opposing to each other. Further, it has been necessary to maintain the position at the time of the connection during the communication due to its directivity. On the other hand, in the communication system using a high frequency signal such as the Bluetooth® communication, such restriction on the position becomes not necessary.

When the Bluetooth® communication is used, an inquiry message is transmitted as a broadcast message from a device which intends to start communication (hereinafter, referred to as a device A) in order to discover devices which exist in the neighborhood thereof. Then, a device which has received the inquiry message from the device A sends back a response message to the device A in response to the inquiry message. By receiving the response messages successively from respective devices which exist in the neighborhood, the device A can discover a plurality of communicable devices which exist in the neighborhood. In accordance with information of those response messages, the device A selects and specifies a device to which the connection is tried, and connection processing with respect to the device is performed. On this occasion, when the response messages are received from a plurality of devices, conventionally those are displayed in a form of list so that a user can make a selection.

In the Bluetooth® communication, not only a communication path is established, but also a kind of application and service implemented in the communication path is defined clearly as a profile. As the profile, there are a serial port profile to perform serial communication, a personal area networking profile to obtain a personal area network and the like. A service discovery protocol (hereinafter, referred to as an SDP) is defined as a procedure to determine those profiles and a service which is actually implemented.

The device A transmits to a device to be connected (hereinafter, referred to as a device B) an inquiry message querying a kind of service provided by the device B in accordance with the SDP, the device B receives the inquiry message from the device A and then transmits to the device A information regarding a service provided by the device B as a response message to the inquiry. If the device B provides a desired service, the device A having received the response message requests the communication for the service, so that the desired service can be started between the device A and the device B.

As described above, a basic communication procedure in the Bluetooth® communication is that the device A first performs transmission of an inquiry message in order to discover devices which exist in the neighborhood and also performs reception of a response message thereto; selects a desired device from devices which have responded; further, makes an inquiry to the device whether the desired service is available; and furthermore, requests the communication for that service.

The Bluetooth® standard is managed by Bluetooth SIG Inc. and specifications describing the details are published by Bluetooth SIG Inc.

Hereupon, in a close range wireless communication system such as the Bluetooth® communication, an inquiry message to discover a device which exists in the neighborhood is targeted at all devices which exist within a communicable range (for example, from 10 m to 100 m). Accordingly, when a number of communicable devices exist in the neighborhood, enormous number of response messages are to be received. Conventionally, such an operation procedure of showing in a display or the like information regarding a device included in those response messages is required so that a user can select the desired device; however, when a number of devices exist in the neighborhood, the user must spend a huge amount of time for the selection operation and the usability becomes deteriorated, which has been a problem. Further, in order to judge whether the device is actually a target device to connect or not, information such as an ID that is provided by the device needs to be identified, and therefore, there has been a possibility for the user to make an excessive operation.

In order to solve the above problem, a method of efficiently performing a procedure to discover a device to be connected by altering a reaching range of an inquiry message has been proposed in Japanese Published Patent Application No. 2001-144781, for example. According to the method, the searching range of devices is restricted to a close range to limit the number of devices to be discovered, so that the device to be connected can efficiently be specified.

However, conventionally in processing to alter the reaching range of the inquiry message, a transmission amplifier connected to a circuit of a transmission system is formed of a variable amplifier and transmission power is controlled by controlling an amplification factor of the variable amplifier, so that the reaching range of the inquiry message can be restricted to a close range. Therefore, it is necessary to control the transmission amplifier, and there has been such a problem that complicated power control processing is required.

The present invention is made in view of the above problems, and a communication apparatus employed in a transmission method such as the Bluetooth® communication that requires a signal to search for a device is provided in which the reaching range of the signal is restricted using a simple and favorable configuration only when the search signal is transmitted.

### DISCLOSURE OF THE INVENTION

A first aspect of the present invention is a communication apparatus which performs wireless communication with another communication device existing in the neighborhood, including a transmission processing means for processing a transmission signal; an antenna for wirelessly transmitting an output of the transmission processing means; and an output power regulation means for attenuating the output of the transmission processing means to be output from the antenna when a search signal to search for another communication device is transmitted in a predetermined state from the transmission processing means. With the above configuration, the transmission output power of the search signal can be controlled by only providing the output power regulation means; the output power control can be performed simply and swiftly; and it becomes possible to perform processing in which the search is made only with respect to communication devices disposed in the vicinity of the communication apparatus to be connected, for example, and other communication devices located remotely to some extent are excluded from the search, using such a simple structure.

A second aspect of the present invention is the communication apparatus according to the first aspect of the present invention, in which the output power regulation means is formed of an attenuator selectively disposed between the transmission processing means and the antenna. Accordingly, the transmission output power can be controlled by only performing a changeover control of a switch or the like, and control over the output power can be performed promptly and simply at the time of transmitting the search signal.

A third aspect of the present invention is the communication apparatus according to the first aspect of the present invention, in which the output power regulation means is formed of an variable attenuator disposed between the transmission processing means and the antenna; and when the transmission is performed in a predetermined state, an attenuation amount of the variable attenuator is set large. Accordingly, the output power can be controlled simply by only controlling the attenuation amount of the variable attenuator at the time of transmitting the search signal.

A fourth aspect of the present invention is the communication apparatus according to the first aspect of the present invention, in which the output power regulation means is formed of first and second antennas to which the output of the transmission processing means is selectively supplied; the sensitivity of the second antenna is made lower than that of the first antenna; and when the transmission is performed in a predetermined state, the transmission is performed using the second antenna and in other cases than that, the transmission is performed using the first antenna. Accordingly, the output power can be regulated simply by only performing selection processing of the antenna.

A fifth aspect of the present invention is the communication apparatus according to the first aspect of the present invention, in which when the transmission output power is regulated by the output power regulation means, further a gain of the transmission amplifier provided in the transmission processing means is made lower. Accordingly, it becomes possible to control the transmission output power more efficiently.

A sixth aspect of the present invention is the communication apparatus according to the first aspect of the present invention, in which the antenna is also connected to a reception processing means for processing a reception signal; and with respect to a signal received by the antenna, which is supplied to the reception processing means, the level of the reception signal is made low by the output power regulation means and then the signal is supplied to the reception processing means. Accordingly, the restriction on the output power of the search signal on the transmitting side and the restriction on the reception sensitivity of a response signal to the search signal or the like on the receiving side can be performed using one output power regulation means in common.

A seventh aspect of the present invention is the communication apparatus according to the first aspect of the present invention, in which the antenna is also connected to a reception processing means for processing the reception signal; and with respect to the signal received by the antenna, which is supplied to the reception processing means, the level of the reception signal is also made low by the output power regulation means and then the signal is supplied to the reception processing means and further, when the level of the reception signal is made low by the output power regulation means, a gain of the reception amplifier provided in the reception processing means is made low. Accordingly, the control can be performed more efficiently with respect to the reception output.

### BRIEF DESCRIPTION OF DRAWINGS

FIG. 1 is a block diagram showing an example of a configuration of a communication apparatus according to an embodiment of the present invention;

FIG. 2 is a circuit diagram showing an example of a configuration of a n-type attenuator;

FIG. 3 is a flow chart showing an example of selection processing according to an embodiment of the present invention;

FIG. 4 is a timing chart showing an example of communication according to an embodiment of the present invention;

FIG. 5 is a block diagram showing an example of a configuration (an example using a variable attenuator) according to another embodiment of the present invention;

FIG. 6 is a block diagram showing an example of a configuration (an example in which transmission control is performed with the variable attenuator) according to another embodiment of the present invention;

FIG. 7 is a block diagram showing an example of a configuration (an example in which transmission control and reception control are performed with the variable attenuator) according to another embodiment of the present invention;

FIG. 8 is a block diagram showing an example of a configuration (an example using the variable attenuator) according to another embodiment of the present invention; and

FIG. 9 is a perspective view showing an example of an appearance of an apparatus having the example of the configuration shown in FIG. 8.

### BEST MODE FOR CARRYING OUT THE INVENTION

Hereinafter, an embodiment of the present invention is explained, referring to the attached drawings.

In this embodiment, the present invention is applied to a wireless communication apparatus that performs wireless communication of the Bluetooth® communication which is one of comparatively short range wireless communication methods. Therefore, when it is intended to start communication using this communication apparatus, an inquiry message (hereunder, referred to as a device search signal) to discover a device which exists in the neighborhood is transmitted as explained in the paragraphs of background art. Then, a response message (response signal) to the device search signal is received to discover a device which exists in the neighborhood and processing of establishing the connection to the discovered device for the wireless communication is performed to start the wireless communication.

Further, in this communication apparatus, the transmission output power and the reception sensitivity are normally set to be capable of performing the wireless communication with a communication terminal device of the same transmission method which exists within the range of approximately 10 m radius of the apparatus positioned at the center thereof, for example. However, only when the device search signal is transmitted, the transmission output power is restricted in accordance with an operation mode of the terminal device at that time, so that the wireless communication can be performed only with the communication terminal device which exists within the range of approximately several tens of centimeter radius of the apparatus positioned at the center thereof, for example.

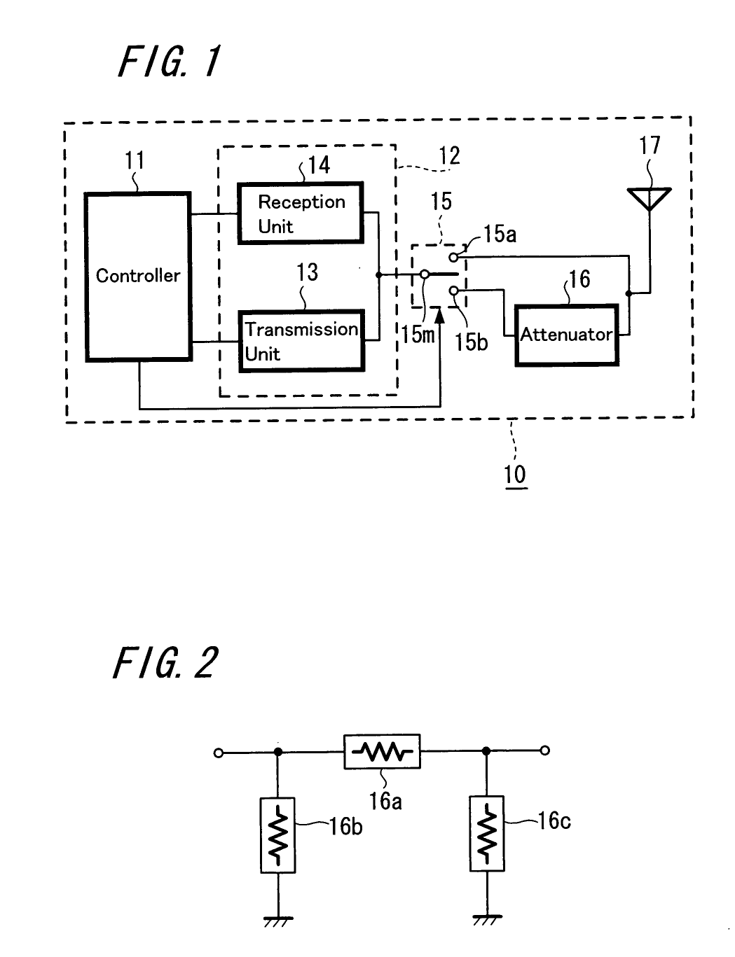

The wireless communication apparatus according to this embodiment is provided as a wireless terminal device having a structure of, for example, a handheld-type information processing terminal device or the like and FIG. 1 is a diagram showing an example of a configuration as the communication apparatus. A wireless terminal device 10 of this embodiment includes a controller 11 which controls the wireless communication, and processing of a transmission signal in a transmission unit 13 and processing of a reception signal in a reception unit 14 in a wireless unit 12 can be performed by the control of the controller 11.

Specifically, in the transmission unit 13, transmission signal processing suitable for a wireless communication method (that is, suitable for the Bluetooth® communication) to which this communication apparatus is applied, such as encoding, packetization, modulation processing and frequency conversion is performed. Further, circuits such as a transmission amplifier and a filter are incorporated in the transmission unit 13 so that the processing of the transmission signal can be performed in those circuits. Similarly, in the reception unit 14, reception processing suitable for the wireless communication method to which this communication apparatus is applied, such as frequency conversion, demodulation processing, separation processing of packet data and decoding is performed. Moreover, circuits such as a reception amplifier and a filter are also incorporated in the reception unit 14 so that the processing of the reception signal can be performed in those circuits.

Further, the wireless terminal device 10 of this embodiment includes an antenna 17 which is used for the transmission and the reception in common, and the antenna 17 is connected to the wireless unit 12. Hereupon, in this embodiment, a switch 15 is provided between the wireless unit 12 and the antenna 17, and a system having an attenuator 16 or a system not having the attenuator can be selected by a changeover of the switch 15.

Specifically, a transmission signal output unit of the transmission unit 13 and a reception signal input unit of the reception unit 14 are connected in common to a movable contact point 15m of the changeover switch 15; a first fixed contact point 15a of this switch 15 is directly connected to a power supply point of the antenna 17; and a second fixed contact point 15b of the switch 15 is connected to the power supply point of the antenna 17 through the attenuator 16. The changeover of the movable contact point 15m of the switch 15 is controlled by the controller 11. Note that, although the switch 15 is indicated as a mechanical switch in the diagram, needless to say, the switch may be formed of an electronic switch such as a semiconductor switch.

As the attenuator 16, various attenuators of a conventional type which uses a resistor or the like can be applied. For example, as shown in FIG. 2, a n-type attenuator including three resistors 16a, 16b and 16c can be employed. Hereupon, it is assumed that the attenuator 16 has the configuration to lower the level of a passing signal by 40 dBm to 50 dBm, for example.

The control over the switch 15 (that is, with or without the attenuator 16) is performed by the controller 11 such that the switch is changed over when the wireless terminal device 10 transmits the search signal in order to discover a communication terminal device (communication station) existing in the neighborhood thereof and in other communication conditions than the above, the movable contact point 15m of the switch 15 is kept in a state of being connected to the side of the first fixed contact point 15a so that the attenuator 16 can not be connected between the wireless unit 12 and the antenna 17.

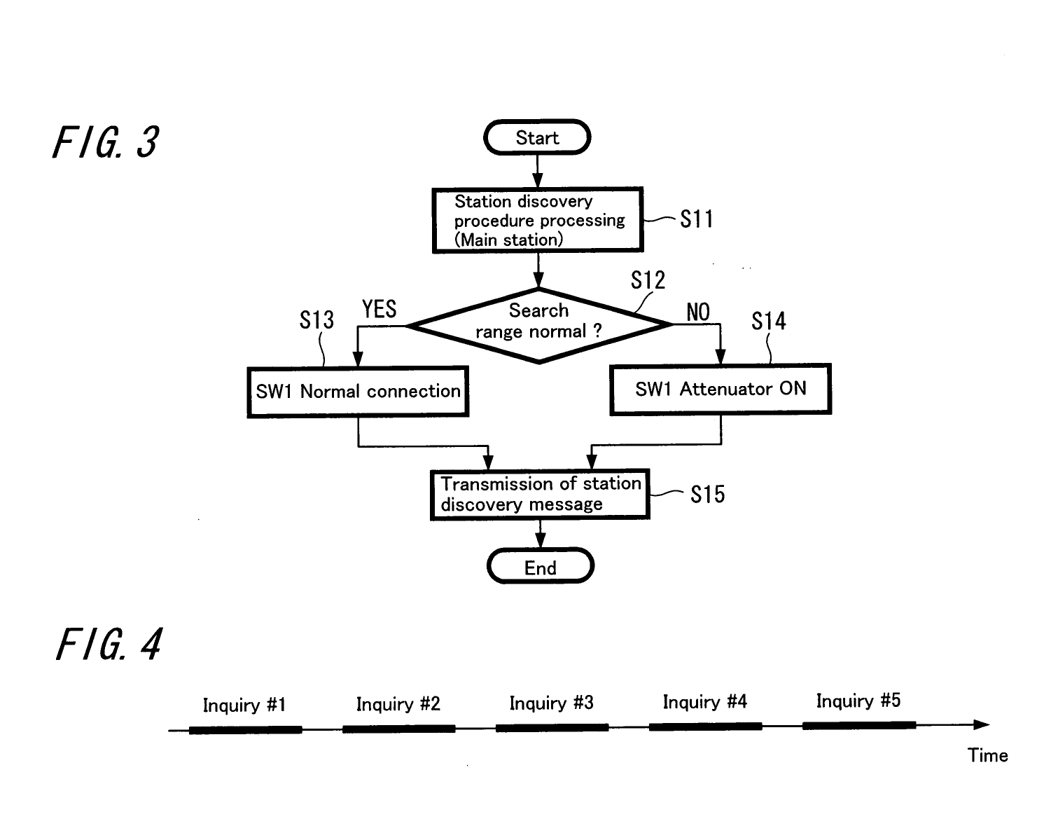

FIG. 3 is a flow chart showing control processing of the switch 15. First, the processing of discovering the communication station existing in the neighborhood is started (Step S11) with the communication terminal device set as a main station, and then it is judged whether a search range of the search signal to be transmitted is a normal range (namely, about 10 m) or not (Step S12). Here, when it is judged to be the normal range, the movable contact point 15m of the switch 15 is brought into the state of being connected to the first fixed contact point 15a (Step S13), so that the attenuator 16 as the output power regulation means is in the state of not being connected to the antenna 17. Further, when the search range of the terminal device is not the normal range (namely, in a state of being restricted to a shorter range than the normal one), the movable contact point 15m of the switch 15 is brought into the state of being connected to the second fixed contact point 15b (Step S14), so that the attenuator 16 as the output power regulation means is in the state of being connected to the antenna 17. Then, the search signal that is the inquiry message to discover a neighboring station is transmitted in the state where the connection of Step S13 or S14 has been established (Step S15).

Transmission of the search signal is periodically and repeatedly performed at the time of inquiry processing. That is, as shown in FIG. 4 for example, the transmission of the first search signal (inquiry #1) is performed for a predetermined period; after that, the transmission of the next search signal (inquiry #2) is performed for the predetermined period after the certain time has passed; and thereafter, the transmission of the search signal is performed repeatedly and intermittently until a response signal can be received or until a predetermined time has passed. During an interval between respective inquiries #1, #2, - - - the communication terminal is in a standby state to receive a response message, for example, transmitted from a terminal device on the receiving side of the search signal.

In this embodiment, as the transmission of the search signal at the time of the inquiry #1 for example, the transmission having the communication range of the normal range (namely, about 10 m) is performed by making the movable contact point 15m of the switch 15 connected to the first fixed contact point 15a not to pass through the attenuator 16; when the search signal is transmitted at the time of the next inquiry #2, the transmission having the communication range of the short range (namely, about several tens cm) is performed by making the movable contact point 15m of the switch 15 connected to the second fixed contact point 15b to pass through the attenuator 16; and then the search of the terminal device existing within the range of about 10-meter radius and the search of the terminal device existing within the range of about several tens cm radius can be performed repeatedly.

Further, the movable contact point 15m of the switch 15 may be fixed to one side according to a search mode at that time, so that the search for only one range, that is, the search of the terminal device existing within the range of about 10-meter radius or the search of the terminal device existing within the range of about several tens cm radius is performed.

Furthermore, when the search signal is transmitted continuously within the short communication range by connecting the movable contact point 15m of the switch 15 to the second fixed contact point 15b to pass through the attenuator 16, the movable contact point 15m of the switch 15 may be connected to the first fixed contact point 15a during the standby period for receiving the response signal at the intervals between respective inquiries #1, #2, #3 - - - as shown in FIG. 4 so that the reception signal can be supplied to the reception unit 14 from the antenna 17 without passing through the attenuator 16, and without lowering the receiving level.

Moreover, in a state of being set to perform the communication within the short range, the movable contact point 15m of the switch 15 may be kept connected to the second fixed contact point 15b also during the period of performing the reception so that the reception signal is supplied from the antenna 17 to the reception unit 14 through the attenuator 16, and the signal having a lowered receiving level is supplied to the reception unit 14. In the case where the wireless communication range is restricted to the short range, when the transmission output power of target devices is the same as that at the normal time, the reception processing of the signal can be performed appropriately even if the reception sensitivity is lowered to some extent.

Thus, with the configuration in which the attenuator 16 that is the output power regulation means of the transmission signal is selectively connected, the reaching range of the transmission signal can be altered without changing the processing in the circuit of the transmission system (for example, without changing a gain of the transmission amplifier or the like), and the reaching range of the search signal to discover the neighboring stations can be changed simply by only performing the changeover of the switch. Accordingly, the operation, in which the transmission output power is set low, for example, only during the period of transmitting the search signal within the short search range and the output power of the transmission signal is returned to be normal at the time of transmitting the search signal within the normal range, at a time of transmitting the other signals, or during a receiving period, can be performed simply by only changing over the switch using a simple control processing structure.

Further, since the output power of the transmission signal is made lower using the attenuator, the amount of attenuation can be set without restriction by selecting a value of an element (resistor) constituting the attenuator; the attenuation amount can be made relatively large; and there is effectiveness in which the above described switchover between the transmission having the reaching range of approximately 10-meter radius and the transmission having the reaching range of approximately several tens centimeter radius can be carried out quickly using the simple structure.

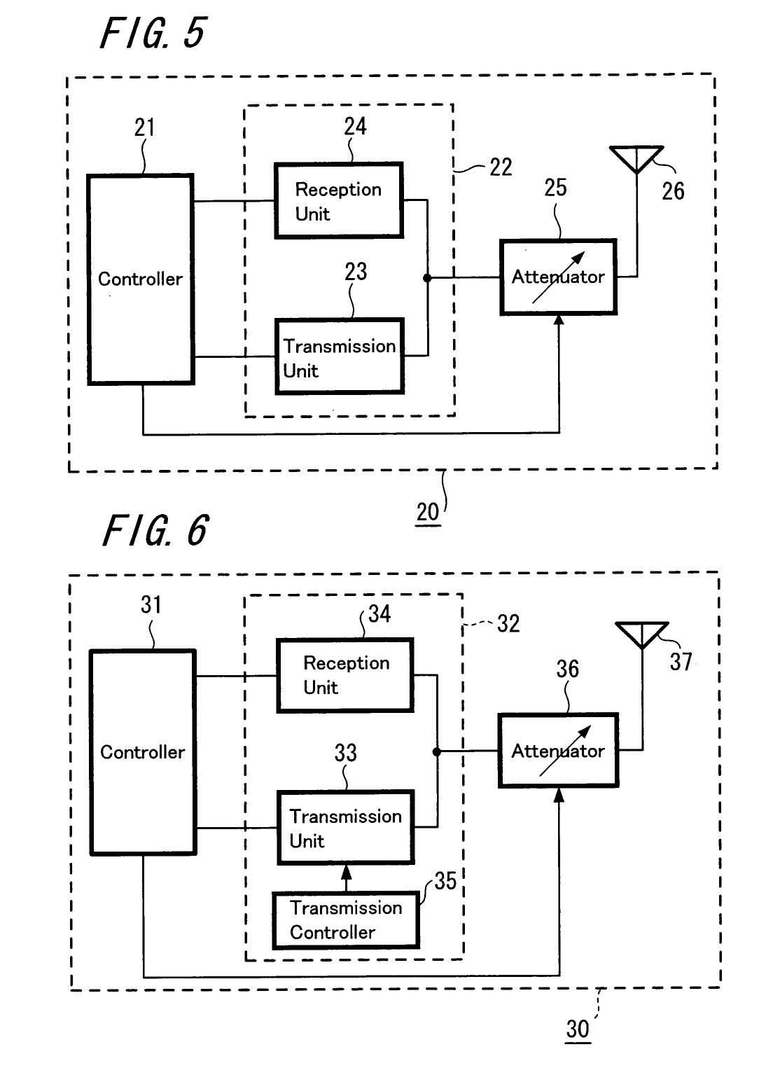

Further, in the structure heretofore explained, the output power regulation means selectively disposed has the structure in which the insertion of the attenuator is carried out by changeover of the switch; however, it is also possible to have the structure in which a variable attenuator is used to set the amount of attenuation variably. Specifically, as shown in FIG. 5 for example, a wireless terminal device 20 includes a controller 21 which controls the wireless communication, and processing of a transmission signal in a transmission unit 23 and processing of a reception signal in a reception unit 24 in a wireless unit 22 can be performed by the control of the controller 21.

Then, an output unit of the transmission signal of the transmission unit 23 and an input unit of the reception output of the reception unit 24 are connected in common to an antenna 26 through a variable attenuator 25. The amount of attenuation of the variable attenuator 25 is controlled by the controller 21, for example. In the variable attenuator 25, a state in which a level of a passing signal is scarcely attenuated or a state in which the signal level is lowered to an extent of approximately 40 dBm to 50 dBm can be selected. Further, an attenuation amount between the above two states can also be selected.

With such configuration, instead of performing the processing of changing over the switch 15 in the wireless terminal device 10 having the structure shown in the above described FIGS. 1 through 3, the attenuation amount of the variable attenuator 25 can be controlled variably, in which the attenuation amount increases at the time of transmitting the search signal in the short range or the like and the attenuation amount decreases in other cases than that, so that the similar processing to that performed in the above described wireless terminal device 10 can be performed. In the case of the wireless terminal device 20, there is no need to change the processing in the transmission unit 23 and the reception unit 24 in the wireless unit 22 regardless of the communication range, and therefore the changeover control can be performed simply and promptly.

In addition, when the structure in which the attenuation amount in the variable attenuator 25 can be selected without restriction is used, the reaching range at the time of transmitting the search signal in the short range can be set freely and variably by user's setting, for example. For example, the user may input the range that the search signal can reach; the input range is converted into the attenuation amount on the side of the controller 21; and the obtained attenuation amount is set in the variable attenuator 25.

Further, since a practical attenuation amount by which a single attenuator can attenuate a signal without causing distortion to a passing signal is conventionally restricted to a value of a certain extent, the gain control of the transmission amplifier in the transmission processing unit can be combined to use when a larger attenuation amount is required. Specifically, as shown in FIG. 6, for example, a wireless terminal device 30 includes a controller 31 which controls the wireless communication, and processing of a transmission signal in a transmission unit 33 and processing of a reception signal in a reception unit 34 in a wireless unit 32 can be performed by the control of the controller 31. In this case, a gain of the transmission amplifier (not shown) in the transmission unit 33 is controlled by a transmission controller 35.

Further, an output unit of the transmission signal of the transmission unit 33 and an input unit of the reception output of the reception unit 34 are connected in common to an antenna 37 through a variable attenuator 36. An attenuation amount of the variable attenuator 36 is controlled by the controller 31, for example. In the variable attenuator 36, the state in which the passing signal level is scarcely attenuated or the state in which the passing signal level is lowered by the extent of 40 dBm to 50 dBm can be selected. Moreover, the transmission amplifier in the transmission unit 33 has a structure in which the signal level can be changed by an amount of 10 dBm to 20 dBm.

With such configuration, when the search signal having the search range restricted to the short range is transmitted, a larger attenuation amount can be selected, and therefore the ratio of the search range at the time of performing the communication to the search range restricted to the short range can be set considerably large.

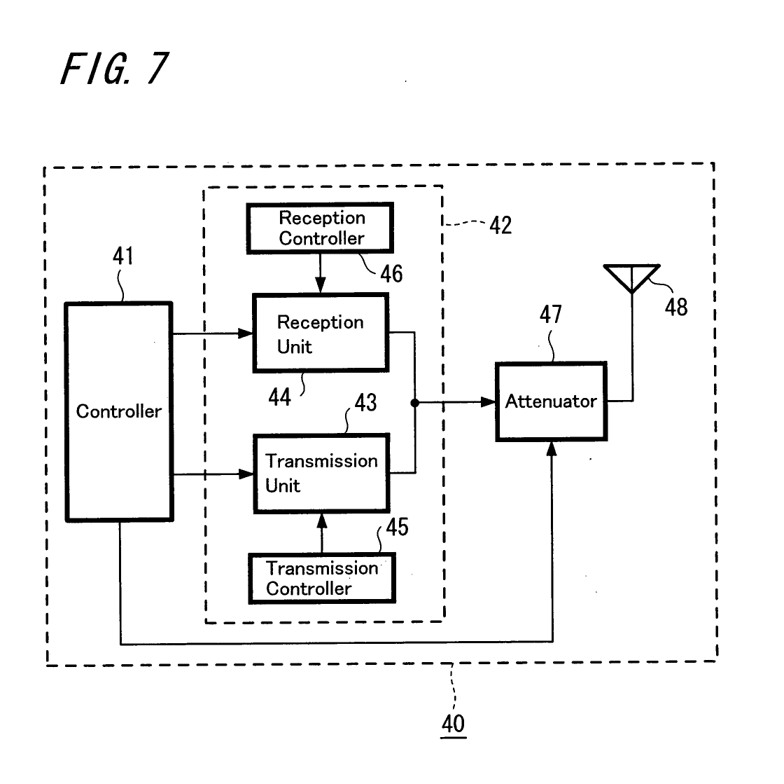

In addition, when it is necessary to restrict greatly the sensitivity at the time of reception, the gain of the reception amplifier provided in the reception unit may also be restricted. Specifically, as shown in FIG. 7 for example, a wireless terminal device 40 includes a controller 41 which controls the wireless communication, and processing of a transmission signal in a transmission unit 43 and processing of a reception signal in a reception unit 44 in a wireless unit 42 can be performed by the control of the controller 41. In this case, the gain of the transmission amplifier (not shown) in the transmission unit 43 is controlled by a transmission controller 45, and the gain of the reception amplifier (not shown) in the reception unit 44 is controlled by a reception controller 46.

Further, an output unit of the transmission signal of the transmission unit 43 and an input unit of the reception output of the reception unit 44 are connected in common to an antenna 48 through a variable attenuator 47. The amount of attenuation of the variable attenuator 47 is controlled by the controller 41, for example. In the variable attenuator 47, the state in which the passing signal level is scarcely attenuated or the state in which the passing signal level is lowered by the amount of 40 dBm to 50 dBm can be selected. Moreover, the transmission amplifier in the transmission unit 43 and the reception amplifier in the reception unit 44 each have the structure in which the signal level can be changed by the amount of approximately 10 dBm to 20 dBm.

With such configuration, it becomes possible to select a larger attenuation amount not only at the time of transmitting the search signal having the search range restricted to the short range but also at the time of receiving a response signal to the search signal.

In addition, it is also possible to include an attenuator having a fixed attenuation amount and a changeover switch as shown in FIG. 1 instead of those variable attenuators in FIGS. 6 and 7.

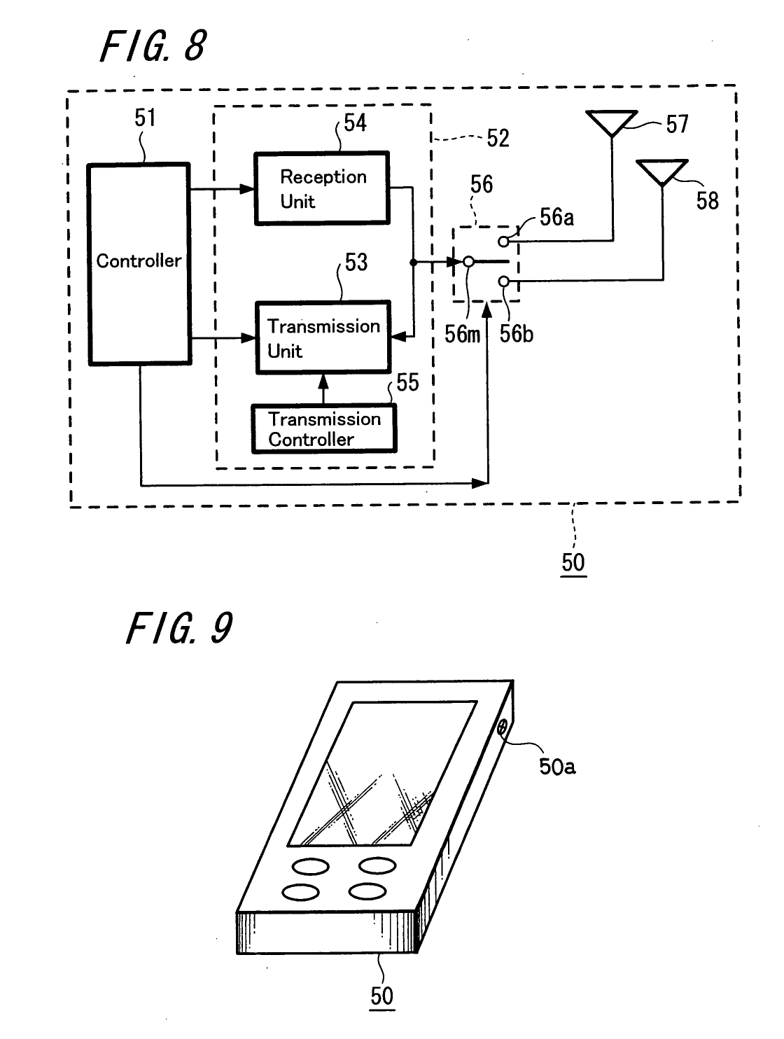

Furthermore, it is also possible to have a structure in which a plurality of antennas each having different efficiency are provided as means for regulating the transmission output power, and the transmission output power can be changed by a changeover of those antennas. Specifically, as shown in FIG. 8 for example, a wireless terminal device 50 includes a controller 51 which controls the wireless communication, and processing of a transmission signal in a transmission unit 53 and processing of a reception signal in a reception unit 54 in a wireless unit 52 can be performed by the control of the controller 51. In this case, the gain of the transmission amplifier (not shown) in the transmission unit 53 is controlled by a transmission controller 55.

Further, an output unit of the transmission signal of the transmission unit 53 and an input unit of the reception output of the reception unit 54 are connected in common to a movable contact point 56m of a changeover switch 56. A first fixed contact point 56a of the changeover switch 56 is connected to an antenna 57 which has a higher transmission (reception) sensitivity. Also, a second fixed contact point 56b of the changeover switch 56 is connected to an antenna 58 which has a lower transmission (reception) sensitivity.

As the antenna 57 which has the higher transmission sensitivity, an antenna having, for example, a structure suitable for a signal of 2.4 GHz band used in the Bluetooth® communication standard is provided. As the antenna 58 which has the lower transmission sensitivity, an antenna having a structure in which a simple signal line is terminated in an impedance on the ground or a structure in which no member functioning as an antenna is practically included is provided.

Further, in the case where the transmission range of the search signal is shortened, the movable contact point 56m of the switch 56 is connected to the side of the second fixed contact point 56b to perform the wireless transmission using the antenna 58 having the lower sensitivity, and in other cases than that, the movable contact point 56m of the switch 56 is connected to the side of the first fixed contact point 56a to be able to perform favorably the wireless transmission. In addition, when an amount of restriction on a signal is not sufficiently obtained by the changeover of the antenna sensitivity, it is also possible to compensate by lowering the gain of the transmission amplifier in the transmission unit 53. Further, it is also possible to provide an attenuator between the second fixed contact point 56b of the switch 56 and the antenna 58.

In addition, when two antennas 57 and 58 are used by changing them over as shown in FIG. 8, an antenna having almost no directivity may be used as the antenna of the higher sensitivity, for example, and an antenna having high directivity may be used as the antenna of the lower sensitivity. Thus, when the search signal is transmitted by the antenna having high directivity, a range where the search signal can reach becomes restricted accordingly, and therefore a similar effectiveness to the case where the reaching range is shortened can be practically obtained.

Further, when the antenna having no directivity and the antenna having high directivity are used selectively, a direction of the directivity of the antenna having high directivity may be displayed in the wireless terminal device 50. For example, as shown in FIG. 9, an approach position indication 50a to indicate the direction of the antenna's directivity is made to be displayed by printing or the like on an outside of the wireless terminal device 50 constituting a handheld information terminal device, and by bringing another device in the direction of indication 50a existing, the approached device can be searched.

Moreover, when a plurality of antennas are provided, it is also possible to change over a polarized plane of the antenna instead of such changeover of the directivity. For example, when an output power restriction is required, an antenna having circular polarization can be used.

Further, in the structure heretofore explained, an explanation is not specifically made with respect to the whole construction of a device to which the communication apparatus is incorporated; however it is obvious that the communication apparatus of the present invention is applicable to various electronic devices to which this kind of communication apparatus is incorporated. For example, similar processing can be performed by incorporating (or, externally attaching) a short range wireless communication unit according to such as the Bluetooth® communication into a handheld information terminal device, a personal computer apparatus, a mobile phone unit, a digital camera, a digital video camera, a television receiver, a portable music player, a headphone and the like.

Furthermore, with respect to the wireless communication method, the explanation is made to an example in which Bluetooth® communication is applied; however, the present invention can be applied to another wireless communication method as well.

### INDUSTRIAL APPLICABILITY

According to the present invention, the transmission output power of the search signal can be controlled by only providing the output power regulation means; the output power control can be performed simply and promptly; and the processing, in which the search is made only with respect to the communication apparatus disposed in the vicinity of the relevant communication apparatus to be connected, for example, excluding other communication devices positioned remotely to some extent, can be obtained using the simple structure.

### DESCRIPTION OF REFERENCE NUMERALS

10 - - - WIRELESS TERMINAL DEVICE
11 - - - CONTROLLER
12 - - - WIRELESS UNIT
13 - - - TRANSMISSION UNIT
14 - - - RECEPTION UNIT
15 - - - SWITCH
16 - - - ATTENUATOR
16a, 16b, 16c - - - RESISTOR
17 - - - ANTENNA
20 - - - WIRELESS TERMINAL DEVICE
21 - - - CONTROLLER
22 - - - WIRELESS UNIT
23 - - - TRANSMISSION UNIT
24 - - - RECEPTION UNIT
25 - - - VARIABLE ATTENUATOR
26 - - - ANTENNA
30 - - - WIRELESS TERMINAL DEVICE
31 - - - CONTROLLER
32 - - - WIRELESS UNIT
33 - - - TRANSMISSION UNIT
34 - - - RECEPTION UNIT
35 - - - TRANSMISSION CONTROLLER
36 - - - VARIABLE ATTENUATOR
37 - - - ANTENNA
40 - - - WIRELESS TERMINAL DEVICE
41 - - - CONTROLLER
42 - - - WIRELESS UNIT
43 - - - TRANSMISSION UNIT
44 - - - RECEPTION UNIT
45 - - - TRANSMISSION CONTROLLER
46 - - - RECEPTION CONTROLLER
47 - - - VARIABLE ATTENUATOR
48 - - - ANTENNA
50 - - - WIRELESS TERMINAL DEVICE
50a - - - APPROACH POSITION INDICATION
51 - - - CONTROLLER
52 - - - WIRELESS UNIT
53 - - - TRANSMISSION UNIT
54 - - - RECEPTION UNIT
55 - - - TRANSMISSION CONTROLLER
56 - - - SWITCH
57, 58 - - - ANTENNA

1-7. (canceled)

8. A communication apparatus which performs wireless communication with another communication device existing in the neighborhood, comprising:
transmission processing means for processing a transmission signal;
first and second antennas to which an output of said transmission processing means is selectively supplied, in which said second antenna is formed of a signal line terminated in an impedance on the ground and the sensitivity thereof is made lower than that of said first antenna; and
output power control means for making the output of said transmission processing means output from said first antenna or from said second antenna when a search signal to search for other communication devices is transmitted from said transmission processing means, in which said second antenna is used to transmit the output in a predetermined state and said first antenna is used in other cases than that.

9. The communication apparatus according to claim 8, wherein
when said output power control means performs control to make said second antenna perform transmission output, further a gain of a transmission amplifier provided in said transmission processing means is made lower.

10. The communication apparatus according to claim 8, wherein
said first and second antennas are also connected to reception processing means for processing a reception signal, and a signal which is received by said first and second antennas and which is selectively supplied to the reception processing means is also supplied to said reception processing means.
